(19) United States
(12) Patent Application Publication
(10) Pub. No.: US 2005/0227748 A1
(43) Pub. Date: Oct. 13, 2005

(54) Direction-agile antenna controller

(75) Inventors: Pertti Visuri, Fallbrook, CA (US); David B. Robison, Carlsbad, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: Airgain, Inc.

(21) Appl. No.: 11/105,040

(22) Filed: Apr. 13, 2005

Related U.S. Application Data
(60) Provisional application No. 60/562,053, filed on Apr. 13, 2004.

(51) Int. Cl. H04B 7/00; H04B 1/04; H01Q 11/12

(52) U.S. Cl. 455/575.7; 455/562.1

(57) ABSTRACT

Method and apparatus for retrofitting wireless devices to control a direction-agile antenna. Alternative solutions include pulse code modulating either the RF signal or a DC bias applied to the RF signal or by applying a PCM signal to the existing LED indicator light which is sensed at an optical receiver.

### CROSS-RELATED APPLICATIONS

This application claims priority from U.S. Provisional Patent Application Ser. No. 60/562,053 filed Apr. 13, 2004.

### BACKGROUND OF THE INVENTION

1. Field of the Invention

The present invention relates generally to controlling direction-agile antennas and more specifically to retrofitting an existing wireless device to control such an antenna.

2. Background Art

There are a number of wireless devices that provide neither the reach nor the range required by end-users. Available solutions include pointed directional antennas and range extenders in which increased coverage distance is obtained by limiting the directional coverage of the signal wave propagation pattern. These solutions are essentially trade-offs between coverage and increased signal gain.

U.S. Pat. No. 6,486,832 B1 owned by Airgain, Inc. (formerly known as AM Group Corporation), describes a direction-agile antenna system for communications in a wireless network, generally comprising an antenna capable of transmitting an electromagnetic signal in a direction having an antenna gain; and a controller connected to the antenna, that is capable of generating a direction-selection signal to steer the electromagnetic signal to a selected direction corresponding to a high gain position in response to detecting an expected signal transmitted within the network.

Implementing a direction-agile antenna system in new wireless devices is relatively simple to do. The challenge is retrofitting wireless devices that have been sold to end-users, specifically in controlling the direction-agile antenna that will replace, for instance, the standard dipole antenna.

Several solutions for the controlling function are possible, including updating the wireless device firmware as provided, for example, in Airgain's Ethernet Wireless Bridge product. However, in this product, there is a dedicated electrical connector that carries the agile-antenna control signals. Existing wireless devices that require retrofitting do not have such a dedicated electrical connector.

### SUMMARY OF THE INVENTION

There are a number of alternative solutions provided by embodiments of the present invention including:
1. Modulating the wireless device RF connection signals in the form of patterns which may be read as agile-antenna control signals (see FIG. 1).
2. Modulating a direct current bias to produce patterns which may be read as agile-antenna control signals (see FIG. 2).
3. The third solution disclosed here uses the operating indicator lights on wireless devices to control the antenna pointing direction (see FIG. 3).

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a block diagram of an agile antenna controller which uses modulated RF signals;

FIG. 2 is a block diagram of an agile antenna controller which uses modulating DC bias; and

FIG. 3 is a block diagram of an agile antenna controller which uses pulse code modulated LED light signals.

### DETAILED DESCRIPTION OF PREFERRED EMBODIMENTS

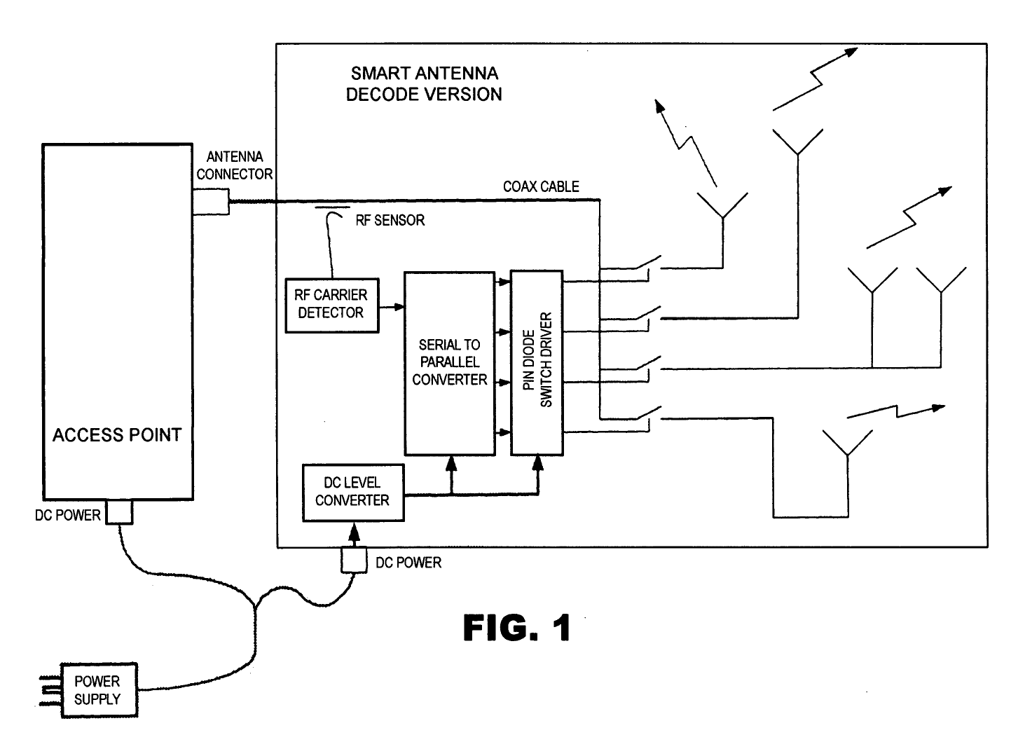

As shown in FIG. 1 the access point is equipped with software to determine the direction to point the smart antenna. This information is provided to the smart antenna, in serial data form, by rapidly toggling the transmit RF signal, on and off. The toggling provides a serial PCM OOK data stream containing the antenna switch command. When decoded by the RF carrier detect circuit and serial to parallel converter the antenna will be steered in the direction requested by the access point software through the PCM OOK signal.

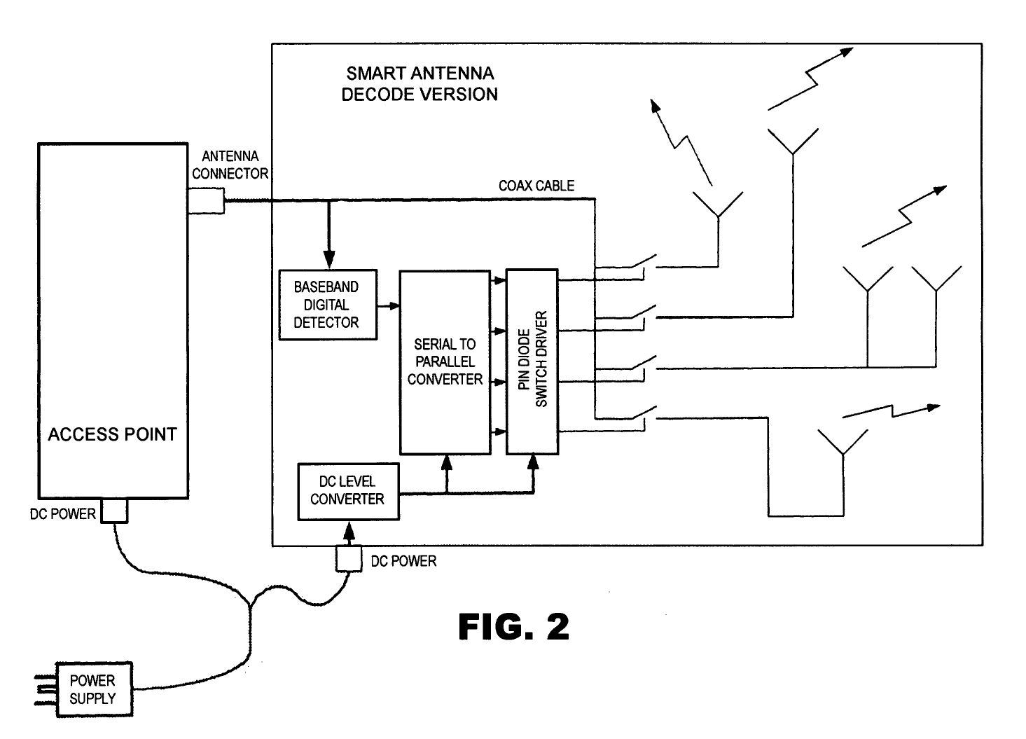

As shown in FIG. 2 the access point is equipped with software to determine the direction to point the smart antenna. This information is provided, in serial data form, by rapidly toggling a DC level, on and off. This DC level is superimposed on the RF output from the access point. The toggling generates a serial data stream containing the antenna switch command. This command, when decoded by the baseband digital decoder circuit and serial to parallel converter will cause the antenna to be steered in the direction determined by the access point.

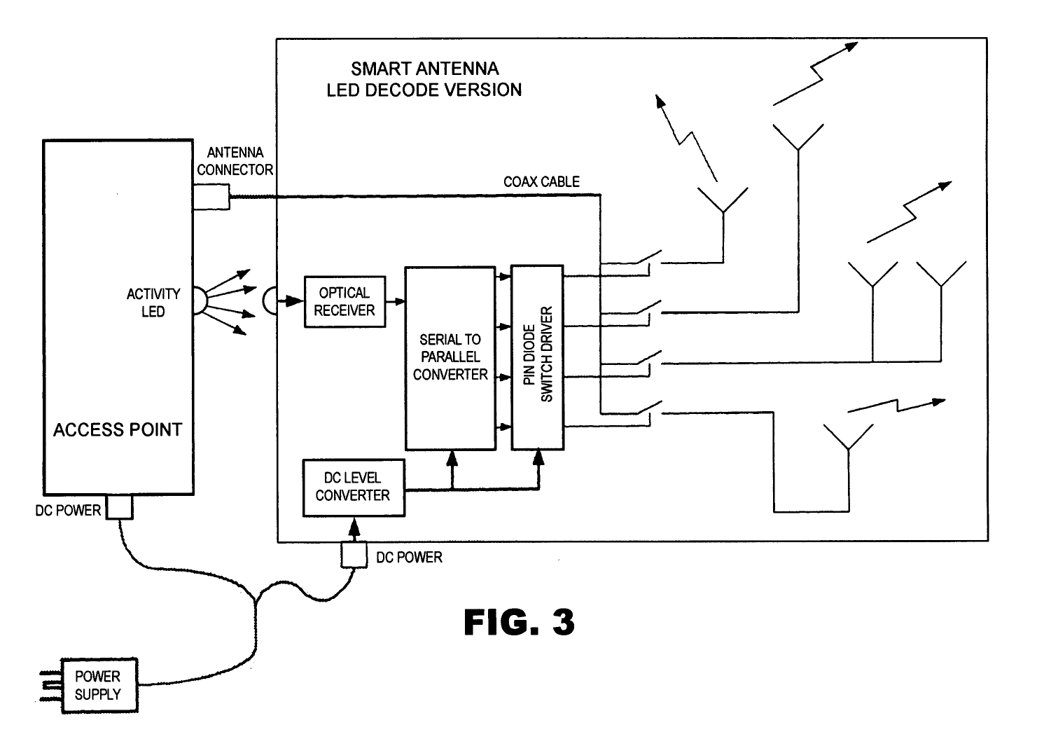

As shown in FIG. 3 the access point is equipped with software to determine the direction to point the smart antenna. This information is provided to the smart antenna, in serial data form, by rapidly toggling the access point activity LED, on and off. The toggling provides a serial PCM OOK data stream containing the antenna switch command. When decoded by the optical receiver circuit and serial to parallel converter, the antenna will be steered in the direction requested by the access point software through the PCM OOK signal.

Operating indicator lights are light emitting diodes which indicate certain electronic activities within a wireless device. They indicate on or off modes and are controlled by microprocessors inside the wireless device unit.

By incorporating additional software in the microprocessors, additional control signals which may take the form of high-frequency, pulse-code modulated signals invisible to the naked eye, are generated to steer the electromagnetic signal transmitted through the direction-agile antenna. These control signals can be in the form of binary information which manifest the numbers 1, 2, 3 . . . , n. The signals are transmitted in serial form and read by an optical receiver (see FIG. 3), then converted to parallel signals through a serial to parallel converter which, in turn, drives a pin diode switch driver that turns certain direction-agile antennas on and off.

The serial to parallel converter and the pin diode switch driver in the retrofitted wireless device are powered by direct current which is obtained through a branched cable power supply.

Having thus disclosed preferred illustrative embodiments of the invention, it being understood that various modifications, additions and alternative applications are contemplated and that the scope of protection hereof is limited only by the appended claims and their equivalents.

1. A method of retrofitting an RF signal wireless communications device having an antenna with a fixed gain characteristic to instead employ a direction-agile antenna responsive to an antenna-pointing signal to steer the direction-agile antenna to generate its antenna gain in a selected direction; the method comprising the steps of:
a) replacing the fixed gain antenna with said direction-agile antenna;
b) generating an antenna-pointing signal;
c) modulating the RF signal of said wireless communications device with said antenna-pointing signal;
d) detecting said antenna-pointing signal modulating said RF signal; and
e) applying said detected antenna-pointing signal to said direction-agile antenna.

2. The method recited in claim 1 wherein step b) comprises the step of configuring said antenna-pointing signal as a serial pulse code modulated data stream.

3. The method recited in claim 2 further comprising the step of converting said detected antenna-pointing signal from said serial pulse code modulated data stream to a parallel format before performing step e).

4. A method of retrofitting an RF signal wireless communications device having an antenna with a fixed gain characteristic to instead employ a direction-agile antenna responsive to an antenna-pointing signal to steer the direction-agile antenna to generate its antenna gain in a selected direction; the method comprising the steps of:
a) replacing the fixed gain antenna with said direction-agile antenna;
b) generating an antenna-pointing signal;
c) superimposing a DC level on the RF signal of said wireless communications device;
d) modulating said DC level with said antenna-pointing signal;
e) employing a baseband digital decoder circuit to decode said modulated DC level to regenerate said antenna-pointing signal; and
f) applying said regenerated antenna-pointing signal to said direction-agile antenna.

5. The method recited in claim 4 wherein step b) comprises the step of configuring said antenna-pointing signal as a serial pulse code modulated data stream.

6. The method recited in claim 5 further comprising the step of converting said decoded antenna-pointing signal from said serial pulse code modulated data stream to a parallel format before performing step f).

7. A method of retrofitting a wireless communications device having an antenna with a fixed gain characteristic to instead employ a direction-agile antenna responsive to an antenna-pointing signal to steer the direction-agile antenna to generate its antenna gain in a selected direction; the method comprising the steps of:
a) replacing the fixed gain antenna with said direction-agile antenna;
b) generating an antenna-pointing signal;
c) modulating an LED activity light of said wireless communications device with said antenna-pointing signal;
d) employing an optical detector to detect said antenna-pointing signal modulating said LED activity light; and
e) applying said detected antenna-pointing signal to said direction-agile antenna.

8. The method recited in claim 7 wherein step b) comprises the step of configuring said antenna-pointing signal as a serial pulse code modulated data stream.

9. The method recited in claim 8 further comprising the step of converting said detected antenna-pointing signal from said serial pulse code modulated data stream to a parallel format before performing step e).

10. A method of retrofitting a wireless communications device having an antenna with a fixed gain characteristic to instead employ a direction-agile antenna responsive to an antenna-pointing signal to steer the direction-agile antenna to generate its antenna gain in a selected direction; the method comprising the steps of:
a) replacing the fixed gain antenna with said direction-agile antenna;
b) generating an antenna-pointing signal;
c) selecting a signal available in said wireless communications device and modulating said selected signal with said antenna-pointing signal;
d) detecting said modulating antenna-pointing signal at a location between said wireless communications device and said direction-agile antenna; and
e) applying said detected antenna-pointing signal to said direction-agile antenna.

11. The method recited in claim 10 wherein step b) comprises the step of configuring said antenna-pointing signal as a serial pulse code modulated data stream.

12. The method recited in claim 11 further comprising the step of converting said detected antenna-pointing signal from said serial pulse code modulated data stream to a parallel format before performing step e).

13. A method of providing a wireless communications device having a direction-agile antenna responsive to an antenna-pointing signal to steer the direction-agile antenna to generate its antenna gain in a selected direction; the method comprising the steps of:
a) generating an antenna-pointing signal;
b) selecting a signal available in said wireless communications device and modulating said selected signal with said antenna-pointing signal;
c) detecting said modulating antenna-pointing signal at a location between said wireless communications device and said direction-agile antenna; and
d) applying said detected antenna-pointing signal to said direction-agile antenna.

14. The method recited in claim 13 wherein step a) comprises the step of configuring said antenna-pointing signal as a serial pulse code modulated data stream.

15. The method recited in claim 14 further comprising the step of converting said detected antenna-pointing signal from said serial pulse code modulated data stream to a parallel format before performing step d).
